(19) United States
(12) Patent Application Publication
(10) Pub. No.: US 2025/0326878 A1
(43) Pub. Date: Oct. 23, 2025

(54) ACTIVE RAY-CURABLE COMPOSITION, METHOD FOR PRODUCING CURED FILM, CURED FILM, AND CURED FILM PRODUCTION DEVICE

(71) Applicant: Konica Minolta, Inc., Tokyo (JP)

(72) Inventors: Takamune HATTORI, Tokyo (JP); Masato NISHIZEKI, Tokyo (JP)

(21) Appl. No.: 18/867,256

(22) PCT Filed: May 15, 2023
(86) PCT No.: PCT/JP2023/018166

§ 371 Date: Nov. 19, 2024

(30) Foreign Application Priority Data
May 25, 2022 (JP) 2022-085423

(51) Int. Cl. C08F 265/06; B41J 2/01; C08F 2/50; C09D 11/38

(52) U.S. Cl. CPC C08F 265/06; B41J 2/01; C08F 2/50; C09D 11/38

(57) ABSTRACT

The present invention provides an active ray-curable composition which is capable of increasing discharge stability based on the inkjet method while increasing the durability of the cured film in high-temperature, high-humidity environments and in low-temperature environments, and the durability of a cured film to bending. The active ray-curable composition according to the present invention contains the following components (A)-(D), and the viscosity thereof at 25° C. is 10-200mPa·s, inclusive: component (A), a (meth)acrylic polymer which has a weight-average molecular weight of 10,000-150,000, inclusive, and a hydroxyl value of 30mgKOH/g or higher; component (B), a (meth)acrylate having a hydroxyl group; component (C), a (meth)acrylate which does not have a hydroxyl group; and component (D), a photopolymerization initiator.

### TECHNICAL FIELD

The present invention relates to an active ray-curable composition, a method for producing a cured film (cured film producing method), a cured film, and an apparatus for producing a cured film (cured film producing apparatus).

### BACKGROUND ART

In various image display devices such as a liquid crystal display device and an organic electroluminescence (organic EL) display device, transparent resins are used as an adhesive for bonding members, a sealing film, a protective film, and the like. As such a transparent resin, a transparent resin obtained by curing a curable resin composition applied by a spin coating method, a die coating method, or the like has been conventionally used, while a curable transparent resin that can be applied by an inkjet method has also been studied in order to enable fine patterning and application to a curved portion or the like.

For example, PTL 1 describes a curable rein composition containing the following: (component A): a (meth)acrylic oligomer having a molecular weight of 5000 or more; (component B): a (meth)acrylic monomer; and (component C): a photoradical polymerization initiator or a thermal radical polymerization initiator and having a viscosity of 150 mPa·s or less. According to PTL 1, the curable resin composition has excellent adhesion between substrates when an inorganic substrate and an organic substrate in an image display device are bonded together, and can be ejected by an inkjet method.

Furthermore, PTL 2 describes a curable composition which contains the following: <component (A)>: a (meth)acrylate polymer having a hydroxyl value of 120 mgKOH/g or more and having no (meth)acryloyl group; <component (B)>: a hydroxyl group-containing monofunctional (meth)acrylate monomer; <component (C)>: a hydroxyl group-free monofunctional (meth)acrylate monomer; and <component (D)>: a hydrogen abstraction type photopolymerization initiator. The curable composition has a viscosity of 10 mPa·s or more at 25° C. and 30 mPa·s or less at 60° C. According to PTL 2, the curable resin composition can be used for forming a cured product to be disposed between an image display member and a light-transmitting cover member when the members are laminated, and can be satisfactorily ejected by an inkjet method.

### CITATION LIST

### Patent Literature

### PTL 1

Japanese Unexamined Patent Publication No. 2017-210578

### PTL 2

Japanese Unexamined Patent Publication No. 2020-106830

### SUMMARY OF INVENTION

### Technical Problem

When a cured product of the curable resin composition as described in PTL 1 is used in an image display device, the the ability to maintain the tackiness (durability) of the cured film in a high-temperature and high-humidity environment or a low-temperature environment may become insufficient, or the durability of the cured film against bending required when the cured film is applied to a flexible display may become insufficient.

According to the findings of the present inventors, these durabilities can be enhanced by using a material having a hydroxyl group as in Patent Literature 2 to impart polarity to the cured film. However, when a material having a hydroxyl group is blended into a composition, ejection stability in an inkjet method may deteriorate. On the other hand, it may be possible when the viscosity of the composition is lowered by lowering the molecular weight of the polymer component (polymer), the ejection stability is improved. However, when the molecular weight of the polymer was decreased, the above-described properties required for the cured film have been deteriorated.

The present invention has been made in view of the above-described problems, and an object of the present invention is to provide an active ray-curable composition capable of enhancing the durability of a cured film in a high-temperature and high-humidity environment or a low-temperature environment and the durability of a cured film against bending while enhancing the ejection stability in an inkjet method, a method for producing a cured film using the active ray-curable composition, a cured film formed from the active ray-curable composition, and an apparatus for producing a cured film using the active ray-curable composition.

### Solution to Problem

An aspect of the present invention for achieving the above-described object relates to the following active ray-curable compositions [1] to [10].

[1] An active ray-curable composition, comprising:
component (A): a (meth)acrylic polymer having a weight average molecular weight of 10,000 or more and 150,000 or less and a hydroxyl value of 30 mgKOH/g or more;
component (B): a (meth)acrylate having a hydroxyl group;
component (C): a (meth)acrylate having no hydroxyl group; and
component (D): a photopolymerization initiator,
wherein,
a viscosity of the active ray-curable composition at 25° C. is 10 mPa·s or more and 200 mPa·s or less.
   [2] The active ray-curable composition according to [1], wherein the component (C) comprises a (meth)acrylate having an alicyclic structure.
   [3] The active ray-curable composition according to [1] or [2], wherein the component (C) comprises a (meth)acrylate having no alicyclic structure.
   [4] The active ray-curable composition according to any one of [1] to [3], wherein the component (B) or the component (C) comprises a polyfunctional (meth)acrylate.
   [5] The active ray-curable composition according to any one of [1] to [4], wherein the component (A) is the (meth)acrylic polymer having the weight average molecular weight of 20,000 or more and 100,000 or less.
   [6] The active ray-curable composition according to any one of [1] to [5], wherein the component (D) is an intramolecular bond cleavage type photopolymerization initiator.
   [7] The active ray-curable composition according to any one of [1] to [6], wherein the component (D) is an acylphosphine oxide-based photopolymerization initiator.
   [8] The active ray-curable composition according to any one of [1] to [7], wherein the component (B) is contained in an amount of 25% by mass or more based on a total mass of the active ray-curable composition.
   [9] The active ray-curable composition according to any one of [1] to [8], wherein the component (A) is the (meth)acrylic polymer having the hydroxyl value of 30 mgKOH/g or more and 120 mgKOH/g or less.
   [10] The active ray-curable composition according to any one of [1] to [9], wherein the active ray-curable composition is an inkjet ink.
   [11] The active ray-curable composition according to any one of [1] to [10], wherein the active ray-curable composition is used for forming a transparent layer of an image display device.

Another aspect of the present invention for achieving the above-described object relates to the following cured film producing method [12].

[12] A method for producing a cured film, the method including:
applying the active ray-curable composition according to any one of [1] to [11]; and
irradiating the applied active ray-curable composition with an active ray.

Another aspect of the present invention for achieving the above-described object relates to the following cured films of [13] and [14].

[13] A cured film obtained by curing the active ray-curable composition according to any one of [1] to [11].
[14] The cured film according to [13], wherein the cured film is a transparent layer of an image display device.

Another aspect of the present invention for achieving the above-described object relates to the following image display device [15].

[15] An image display device comprising the cured film according to [13] or [14]

Furthermore, another aspect of the present invention for achieving the aforementioned object relates to the following cured film producing apparatus [16].

[16] An apparatus for producing a cured film, the apparatus comprising:
an applicator that applies the active ray-curable composition according to any one of [1] to [11] to a substrate; and
an irradiator that irradiates the applied active ray-curable composition with an active ray.

### Advantageous Effects of Invention

According to the present invention, there are provided an active ray-curable composition that can enhance durability of a cured film in a high-temperature and high-humidity environment or a low-temperature environment and durability of a cured film against bending while enhancing ejection stability in an inkjet method, a method for producing a cured film using the active ray-curable composition, a cured film formed from the active ray-curable composition, and an apparatus for producing a cured film using the active ray-curable composition.

### BRIEF DESCRIPTION OF THE DRAWINGS

FIG. 1A to FIG. 1C are diagrams schematically illustrating an exemplary configuration of a cured film producing apparatus for performing a cured film producing method according to an embodiment of the present invention.

### DESCRIPTION OF EMBODIMENTS

### 1. Active Ray-Curable Composition

An embodiment of the present invention relates to an active ray-curable composition including:
component (A): a (meth)acrylic polymer having a weight average molecular weight of 10,000 or more and 150,000 or less and a hydroxyl value of 30 mgKOH/g or more;
component (B): a (meth)acrylate having a hydroxyl group;
component (C): a (meth)acrylate having no hydroxyl group; and
component (D): a photopolymerization initiator.

The viscosity of the actinic radiation-curable composition at 25° C. is 10 mPa·s or more and 200 mPa·s or less.

Note that in the present specification, the term “(meth)acrylic” means acrylic or methacrylic, the term “(meth)acryloyl group” means an acryloyl group or a methacryloyl group, and the term “(meth)acrylate” means acrylate or methacrylate.

### 1-1. Component (A) (Meth)acrylic Polymer

The component (A) is a (meth)acrylic polymer having a weight average molecular weight of 10,000 or more and 150,000 or less, and a hydroxyl value of 30 mgKOH/g or more. Note that the component (A) preferably has no polymerizable group (more specifically, (meth)acryloyl group) in the molecule.

The component (A) imparts tackiness to a cured film formed by curing the active ray-curable composition. In particular, by using a polymer having a hydroxyl group as the component (A), appropriate flexibility due to the use of the polymer and good tackiness due to the hydroxyl group can be imparted to the cured film.

Incidentally, according to the finding by the present inventors, there is a limitation on the range of the molecular weight of the component (A) that can be adopted in order to secure the ejection properties by an inkjet method. When the molecular weight of the component (A) is too large, even when the viscosity of the composition is adjusted to be low by other components as described in PTL 2, stringing tends to occur when the composition is ejected from an inkjet head, and the ejection speed is less likely to be stable. Therefore, it is difficult to form a fine pattern, and therefore it cannot be said that the ejection property in an inkjet method can be satisfactorily ensured. Furthermore, according to the finding of the present inventors, when the molecular weight of the component (A) is increased, the ability of a cured film to maintain its tackiness when placed in a high-temperature and high-humidity environment or a low-temperature environment (the durability of a cured film in a high-temperature and high-humidity environment and a low-temperature environment) tends to decrease. In order to sufficiently ensure ejectability by an inkjet method, the weight average molecular weight of the component (A) is set to 150,000 or less in the present embodiment.

On the other hand, when the molecular weight of the component (A) is reduced, although the ejection property by an inkjet method can be sufficiently ensured, the tackiness is extremely reduced. In particular, the ability to maintain the tackiness when placed in a high-temperature and high-humidity environment or a low-temperature environment (the durability of the cured film in a high-temperature and high-humidity environment and a low-temperature environment), the ability to maintain the tackiness when applied to a flexible display and bent (the durability of the cured film when bent), and the like are extremely reduced. In order to ensure the ability to maintain the tackiness, the weight average molecular weight of the component (A) is set to be 10,000 or more in the present embodiment.

From the above viewpoint, the weight average molecular weight (Mw) of the component (A) is preferably 20,000 or more and 100,000 or less, and more preferably 40,000 or more and 80,000 or less.

Note that the weight average molecular weight (Mw) of the component (A) in the present specification is a weight average molecular weight in terms of polystyrene, which is detected by using HLC-8220GPC (manufactured by Tosoh Corporation), using connected TSG gel SuperMultiporeHZ 4000 (manufactured by Tosoh Corporation), TSG gel SuperMultiporeHZ 3000 (manufactured by Tosoh Corporation), and TSG gel SuperMultiporeHZ 2500 (manufactured by Tosoh Corporation) columns, using tetrahydrofuran (THF) as solvents, setting a column temperature to 40° C., and using an RI (Refractive Index) detector.

Furthermore, in order to impart satisfactory tackiness to a cured film, in particular, to sufficiently enhance the durability of the cured film in the aforementioned high-temperature and high-humidity environment and low-temperature environment, the durability of the cured film when bent, and the like, the hydroxyl value of the component (A) is set to be 30 mgKOH/g or more in the present embodiment.

Note that according to the findings of the present inventors, suppressing the hydroxyl value to an appropriate range suppresses an increase in the viscosity of the ink due to hydrogen bonding between the components (A) to pseudo-polymerize. According to this, it is possible to make it more difficult for stringing to occur when the ink is ejected from the ink jet head, and to make it easy to stabilize the ejection speed. Furthermore, according to the finding of the present inventors, when the hydroxyl value of the component (A) is increased, the durability of the cured film in a low-temperature environment tends to decrease. From the standpoint of enhancing all of these, in particular enhancing all of the durability of the cured film in a low-temperature environment and the stabilization of the ejection speed, the hydroxyl value of the component (A) is preferably 30 mgKOH/g or more and less than 180 mgKOH/g, more preferably 30 mgKOH/g or more and less than 120 mgKOH/g, further preferably 50 mgKOH/g or more and less than 100 mgKOH/g.

The hydroxyl value of the component (A) in the present specification is a value measured using a potentiometric titrator (manufactured by Kyoto Electronics Manufacturing Co., Ltd., AT-500N) and glass electrodes (manufactured by Kyoto Electronics Manufacturing Co., Ltd., C-173) and using, as a titrant, an alcohol solution having a KOH concentration of 0.5 mol/L. To be specific, a sample is weighed in a 200 mL Erlenmeyer flask, an acetylating agent 5 mL is added thereto, and the mixture is reacted in an oil bath at 100° C.±5° C. for 1 hour. After being allowed to cool, 1 mL water is added, and the mixture is reacted in an oil bath of 100° C.±5° C. for 10 minutes, and after being allowed to cool, the mixture is washed with 5 mL ethanol, and 140 mL pyridine is added for dilution. Titration is performed using a potentiometric titrator, and the obtained inflection point is used as the end point. A blank test is also performed in the same manner, and the hydroxyl value is calculated from the following equation.

$$Hydroxyl value ( mg KOH / g ) = ( V 0 - V 1 ) \times N \times 56.11 \times f / S + acid value$$

S: Weight of sample (g)
V0: Amount of titrant required for blank test (mL)
V1: Amount (mL) of titrant required for the present test
N: Concentration of titrant (0.5 mol/L)
f: Titrant factor (1.001)

Note that the acid number in the above calculation formula is a value measured using a potentiometric titrator (AT-500N, manufactured by Kyoto Electronics Manufacturing Co., Ltd), glass electrodes (C-173, manufactured by Kyoto Electronics Manufacturing Co., Ltd) and an alcohol solution with a KOH concentration of 0.1 mol/L as a titrant. To be specific, the sample and 80 mL of a mixed liquid (toluene:methanol=4:1) (volume ratio) were added to a 100 mL Erlenmeyer flask to dissolve the sample. Titration is performed using a potentiometric titrator, and the obtained inflection point is used as the end point. A blank test is also performed in the same manner, and the acid value is calculated by the following formula.

$$Acid number ( mg KOH / g ) = ( V 1 - V 0 ) \times N \times 56.11 \times f / S$$

S: Weight of sample (g)
V0: Amount of titrant required for blank test (mL)
V1: Amount (mL) of titrant required for the present test
N: Concentration of titrant (0.1 mol/L)
f: Titrant factor (1.001)

A (meth)acrylic polymer is used as the component (A) from the viewpoint of enhancing the compatibility with the component (B) and the component (C) to suppress an increase in the viscosity of the ink, thereby suppressing stringing when the ink is ejected from an inkjet head. The component (A) can be, for example, a copolymer of a (meth)acrylate having a hydroxyl group and a (meth)acrylate having no hydroxyl group.

Examples of the (meth)acrylate having a hydroxyl group include 2-hydroxyethyl (meth)acrylate, 2-hydroxypropyl (meth)acrylate, 3-hydroxypropyl (meth)acrylate, 4-hydroxybutyl (meth)acrylate, 2-hydroxy-3-chloropropyl (meth)acrylate, 2-hydroxy-3-phenoxypropyl (meth)acrylate, ethylene glycol (meth)acrylate, polyethylene glycol (meth)acrylate, propylene glycol (meth)acrylate, polypropylene glycol (meth)acrylate, and cyclohexyldimethanol mono (meth)acrylate. These (meth)acrylates having a hydroxyl group may be used alone or in combination of two or more types thereof.

Examples of the (meth)acrylate having no hydroxyl group include (meth)acrylates having a linear or branched alkyl chain having 1 or more and 18 or less carbon atoms. Examples of these (meth)acrylates include methyl (meth)acrylate, ethyl (meth)acrylate, propyl (meth)acrylate, isopropyl (meth)acrylate, n-butyl (meth)acrylate, isobutyl (meth)acrylate, pentyl (meth)acrylate, hexyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, lauryl (meth)acrylate, stearyl (meth)acrylate, isostearyl (meth)acrylate, tridecyl (meth)acrylate and the like. These (meth)acrylates having no hydroxyl group may be used alone or in combination of two or more types thereof.

Other examples of the (meth)acrylate having no hydroxyl group include (meth)acrylates having an alicyclic structure such as isobornyl (meth)acrylate, dicyclopentenyl (meth)acrylate, dicyclopentenyloxyethyl (meth)acrylate, dicyclopentanyl (meth)acrylate, cyclohexyl (meth)acrylate, trimethylcyclohexyl (meth)acrylate, tetrahydrofurfuryl (meth)acrylate, glycidyl (meth)acrylate, γ-butyrolactone (meth)acrylate, γ-butyrolactone (meth)acrylate, and (meth)acryloylmorpholine. These (meth)acrylates having an alicyclic structure may be used alone or in combination of two or more types thereof.

Among these, the component (A) preferably includes, as a constituent unit derived from a (meth)acrylate having no hydroxyl group, a (meth)acrylate having a linear or branched alkyl chain having 1 or more and 18 or less carbon atoms. The proportion of the (meth)acrylate having an alkyl chain is preferably 50% by mass or more and 100% by mass or less, more preferably 70% by mass or more and 100% by mass or less, and still more preferably 70% by mass or more and 90% by mass or less, based on the total mass of the constituent units derived from the (meth)acrylate having no hydroxyl group.

The polymerization ratio of these (meth)acrylates is not particularly limited as long as the hydroxyl value of the component (A) falls within the above-described range.

Note that the component (A) may include, in addition to these constituent units derived from (meth)acrylates, a constituent unit derived from another copolymerizable monomer such as styrene. From the viewpoint of suppressing stringing when ejected from an inkjet head, the ratio of the constituent unit derived from the other monomer is preferably 0% by mass or more and 10% by mass or less and more preferably 0% by mass or more and 5% by mass or less based on the total mass of the copolymer.

The content of the component (A) is preferably 1% by mass or more and 50% by mass or less, more preferably 1% by mass or more and 30% by mass or less, and still more preferably 5% by mass or more and 20% by mass or less, based on the total mass of the active ray-curable composition. When the content is 1% by mass or more, the tackiness of the cured film and the ability to maintain the tackiness are further enhanced. When the content is 50% by mass or less, the viscosity of the active ray-curable composition can be set in an appropriate range and the ejection property from an inkjet head can be improved.

### 1-2. Component (B): (Meth)acrylate Having a Hydroxyl Group

The component (B) is a (meth)acrylate having a hydroxyl group. Note that the component (B) does not include so-called oligomers.

The component (B) moderately increases the strength of the cured film and also provides tackiness due to the hydroxyl group.

The component (B) may be a monofunctional (meth)acrylate having only one (meth)acryloyl group in the molecule, or may be a polyfunctional (meth)acrylate having a plurality of (meth)acryloyl groups in the molecule. Among these, monofunctional (meth)acrylates are preferable from the viewpoint of enhancing the flexibility of curability. Furthermore, in order to enhance both the flexibility and the hardness, a monofunctional (meth)acrylate and a polyfunctional (meth)acrylate may be used in combination.

The component (B) preferably has only one hydroxyl group in the molecule from the viewpoint of suppressing the dispersion variation of the hydroxyl group in the cured film.

Examples of the component (B) include 2-hydroxyethyl (meth)acrylate, 2-hydroxypropyl (meth)acrylate, 3-hydroxypropyl (meth)acrylate, 4-hydroxybutyl (meth)acrylate, 2-hydroxy-3-chloropropyl (meth)acrylate, 2-hydroxy-3-phenoxypropyl (meth)acrylate, ethylene glycol (meth)acrylate, polyethylene glycol (meth)acrylate, propylene glycol (meth)acrylate, polypropylene glycol (meth)acrylate, and cyclohexyldimethanol mono (meth)acrylate. These (meth)acrylates may be used alone or in combination of two or more types thereof.

The content of the component (B) is preferably 1% by mass or more and 50% by mass or less, more preferably 25% by mass or more and 40% by mass or less, based on the total mass of the active ray-curable composition. When the content is 1% by mass or more, the tackiness of the cured film and the ability to maintain the tackiness can be further enhanced while an increase in the viscosity of the ink is suppressed.

### 1-3. Component (C): (Meth)acrylate Having No Hydroxyl Group

The component (C) is a (meth)acrylate having no hydroxyl group. Note that the component (C) does not include so-called oligomers.

The component (C) adjusts the amount of hydroxyl groups in the cured film to an appropriate range and enhances the tackiness of the cured film and the ability to maintain the tackiness.

The component (C) may be a monofunctional (meth)acrylate having only one (meth)acryloyl group in the molecule, or may be a polyfunctional (meth)acrylate having a plurality of (meth)acryloyl groups in the molecule. Among these, monofunctional (meth)acrylates are preferable from the viewpoint of enhancing the flexibility of curability. In order to achieve a balance between flexibility and hardness, a monofunctional (meth)acrylate and a polyfunctional (meth)acrylate may be used in combination.

In particular, from the standpoint of further enhancing the ability of the cured film to maintain its tackiness in a high-temperature and high-humidity environment, the component (C) preferably contains a (meth)acrylate having an alicyclic structure. The (meth)acrylate having an alicyclic structure increases the glass transition temperature (Tg) of the cured film. Thus, the (meth)acrylate having an alicyclic structure reduces the moisture permeability of the cured film, and suppresses a reduction in the tackiness due to the deterioration of the cured film caused by the moisture having entered the cured film.

Examples of the (meth)acrylate having an alicyclic structure include isobornyl (meth)acrylate, dicyclopentenyl (meth)acrylate, dicyclopentenyloxyethyl (meth)acrylate, dicyclopentanyl (meth)acrylate, cyclohexyl (meth)acrylate, and trimethylcyclohexyl (meth)acrylate. These (meth)acrylates having an alicyclic structure may be used alone or in combination of two or more types thereof.

The content of the (meth)acrylate having an alicyclic structure is preferably 1% by mass or more and 50% by mass or less, more preferably 15% by mass or more and 40% by mass or less, based on the total mass of the active ray-curable composition.

From the viewpoint of further enhancing the flexibility of the cured film, the component (C) preferably contains a (meth)acrylate having no alicyclic structure. Note that the component (C) does not include so-called oligomers.

In light of more efficiently enhancing the flexibility of the cured film, the (meth)acrylate having no alicyclic structure is preferably a (meth)acrylate having a linear or branched alkyl chain having 1 or more and 18 or less carbon atoms. Examples of these (meth)acrylates include methyl (meth)acrylate, ethyl (meth)acrylate, propyl (meth)acrylate, isopropyl (meth)acrylate, n-butyl (meth)acrylate, isobutyl (meth)acrylate, pentyl (meth)acrylate, hexyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, lauryl (meth)acrylate, stearyl (meth)acrylate, isostearyl (meth)acrylate, tridecyl (meth)acrylate and the like. These (meth)acrylates having no alicyclic structure may be used alone or in combination of two or more types thereof.

Note that the (meth)acrylate having no alicyclic structure may be a polyfunctional (meth)acrylate. The polyfunctional (meth)acrylate can moderately increase the hardness of the cured film. Examples of the polyfunctional (meth)acrylate include: bifunctional (meth)acrylates such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A-PO adduct di(meth)acrylate, hydroxypivalic acid-neopentyl glycol di(meth)acrylate, polytetramethylene glycol di(meth)acrylate, polyethylene glycol di(meth)acrylate, dipropylene glycol di(meth)acrylate and tripropylene glycol di(meth)acrylate; trifunctional (meth)acrylates such as trimethylolpropane tri(meth)acrylate and pentaerythritol tri(meth)acrylate; (meth)acrylates having three or more functional groups, such as pentaerythritol tetra (meth)acrylate, dipentaerythritol hexa (meth)acrylate, ditrimethylolpropane tetra (meth)acrylate, glycerolpropoxy tri(meth)acrylate, and pentaerythritol ethoxy tetra (meth)acrylate; and modified products thereof. Examples of the modified product include ethylene oxide-modified (EO-modified) (meth)acrylate into which an ethylene oxide group is inserted, and propylene oxide-modified (PO-modified) (meth)acrylate into which propylene oxide is inserted. The polyfunctional (meth)acrylate may be used alone or in combination of two or more types thereof.

From the viewpoint of enhancing both the ability to maintain the tackiness of the cured film and the flexibility thereof, the active ray-curable composition preferably contains, as the component (C), both a (meth)acrylate having an alicyclic structure and a (meth)acrylate having no alicyclic structure.

The content of the component (C) is preferably 30% by mass or more and 85% by mass or less, more preferably 50% by mass or more and 70% by mass or less, based on the total mass of the active ray-curable composition. When the content is 30% by mass or more, the tackiness of the cured film and the ability to maintain the tackiness are further enhanced. When the content is 85% by mass or less, the flexibility of the cured film is further enhanced.

Note that from the viewpoint of enhancing durability of the cured film in a high-temperature and high-humidity environment, the component (B) or the component (C) preferably contains a polyfunctional (meth)acrylate having two or more polymerizable functional groups. The polyfunctional (meth)acrylate may be contained in only one of the component (B) and the component (C), or may be contained in both of the component (B) and the component (C), but is preferably contained in at least the component (C). The content of the polyfunctional (meth)acrylate is preferably 0.1% by mass or more and 5% by mass or less, more preferably 1% by mass or more and 3% by mass or less, based on the total mass of the active ray-curable composition. By increasing the content of the polyfunctional (meth)acrylate, the durability of the cured film in a high-temperature and high-humidity environment can be enhanced due to the crosslinked structure. By decreasing the content of the polyfunctional (meth)acrylate, a decrease in the flexibility of the cured film due to the crosslinked structure can be suppressed.

### 1-4. Component (D): A Photopolymerization Initiator

The component (D) is a photopolymerization initiator.

The component (D) initiates polymerization of the component (B) and the component (C) when irradiated with an active ray, and cures the active ray-curable cured product.

The component (D) is a radically polymerizable photopolymerization initiator.

The component (D) may be a radical polymerization initiator of intramolecular bond cleavage type (intramolecular bond cleavage type radical polymerization initiator) or radical polymerization initiator of intramolecular hydrogen abstraction type (intramolecular hydrogen abstraction type radical polymerization initiator). Among these, the intramolecular bond cleavage type radical polymerization initiator is less likely to initiate polymerization starting from the hydroxyl groups of the component (A) and the component (B) than the intramolecular hydrogen abstraction type radical polymerization initiator. Therefore, the radical polymerization initiator of the intramolecular bond cleavage type hardly forms a crosslinked structure by polymerization with the hydroxyl group as a starting point, makes the cured film more flexible, and can more sufficiently enhance the durability of the cured film when bent.

Examples of the intramolecular bond cleavage type radical polymerization initiator include acetophenone-based initiators such as diethoxyacetophenone, 2-hydroxy-2-methyl-1-phenylpropan-1-one, benzyldimethylketal, 1-(4-isopropylphenyl)-2-hydroxy-2-methylpropan-1-one, 4-(2-hydroxyethoxy) phenyl-(2-hydroxy-2-propyl) ketone, 1-hydroxycyclohexyl-phenylketone, 2-methyl-2-morpholino (4-methylthiophenyl) propan-1-one, and 2-benzyl-2-dimethylamino-1-(4-morpholinophenyl)-butanone; benzoins such as benzoin, benzoin methyl ether, and benzoin isopropyl ether; acylphosphine oxide-based initiators such as 2,4,6-trimethylbenzoin diphenylphosphine oxides; and benzyl and methylphenyl glyoxy esters.

Among these intramolecular bond cleavage type radical polymerization initiators, an acylphosphine oxide-based polymerization initiator is preferable because it has sufficient curability (polymerization initiation property) even when a UV-LED light source is used in order to reduce damage to a substrate. The intramolecular bond cleavage type radical polymerization initiator may be used alone or in combination of two or more types thereof.

Examples of the intramolecular hydrogen abstraction type radical polymerization initiator include benzophenone-based initiators such as benzophenon, methyl o-benzoylbenzoate, 4-phenylbenzophenone, 4,4′-dichlorobenzophenone, hydroxybenzophenone, 4-benzoyl-4′-methyl-diphenyl sulfide, acrylated benzophenon, 3,3′,4,4′-tetra(t-butylperoxycarbonyl) benzophenon and 3,3′-dimethyl-4-methoxybenzophenone, thioxanthone-based initiators such as 2-isopropylthioxanthone, 2,4-dimethylthioxanthone, 2,4-diethylthioxanthone and 2,4-dichlorothioxanthone, aminobenzophenone-based initiators such as Michler's ketone and 4,4′-diethylaminobenzophenone, 10-butyl-2-chloroacridone, 2-ethylanthraquinone, 9,10-phenanthrenequinone and camphorquinone. The intramolecular hydrogen abstraction type radical polymerization initiator may be used alone or in combination of two or more types thereof.

The content of the polymerization initiator may be in a range in which the active ray-curable composition can be sufficiently cured, and for example, can be set to 0.01% by mass or more and 10% by mass or less based on the total mass of the active ray-curable composition.

### 1-5. Other Components

The active ray-curable composition may include other components as long as the above-described effect is sufficiently obtained.

Examples of the other components include a (meth)acrylate oligomer, a color material, a plasticizer, a tackifier, a coupling agent such as a silane coupling agent, an antioxidant, a polymerization inhibitor, a surfactant, a photosensitizer, a polysaccharide, a fungicide, a rust inhibitor, and an ultraviolet absorber. The composition may contain only one of the other components, or may contain two or more of the other components.

Examples of the (meth)acrylate oligomer include epoxy (meth)acrylate oligomers, aliphatic urethane (meth)acrylate oligomers, aromatic urethane (meth)acrylate oligomers, polyoxyalkylene urethane (meth)acrylate oligomers, polyester (meth)acrylate oligomers, and linear (meth) acryl oligomers.

From the viewpoint of further enhancing the flexibility of the cured film, the (meth)acrylate oligomer is preferably an oligomer having less than two functional (meth)acryloyl groups. The (meth)acrylate oligomer preferably has a weight average molecular weight (Mw) of 50,000 or less from the viewpoint of further enhancing the ejection property from an inkjet head. Among these, polyoxyalkylene urethane (meth)acrylate oligomers are preferable from the viewpoint of appropriately imparting polarity to the cured film to further enhance the tackiness and the ability to maintain the tackiness of the cured film.

Examples of the color material include pigments including various organic pigments and inorganic pigments such as carbon black, and dyes.

The content of the color material may be set according to the properties required for the cured film. Specifically, when it is desired to impart a predetermined color tone to the cured film, the content of the color material can be set to 0.1% by mass or more and 20.0% by mass or less and is preferably 0.4% by mass or more and 10.0% by mass or less based on the total mass of the active ray-curable composition. On the other hand, when it is desired to increase the transmittance of a cured film, the content of the color material is preferably 1% by mass or less, and more preferably 0.1% by mass or less, based on the total mass of the active ray-curable composition.

### 1-6. Physical Properties

The viscosity of the active ray-curable composition at 25° C. is 10 mPa·s or more and 200 mPa·s or less. When the viscosity at 25° C. is 10 mPa·s or more, liquid dripping from a nozzle during standby can be suppressed. When the viscosity at 25° C. is 200 mPa·s or less, ejectability from an inkjet head can be secured.

In the present specification, the viscosity of the active ray-curable composition is a value measured under conditions of a shear rate of 1000 (1/s) using a rheometer (manufactured by Anton Paar GmbH, Physica MCR301).

### 1-7. Application

The above-described active ray-curable composition can be used as a so-called inkjet ink that can be ejected from an inkjet head, for forming a cured film in various applications in which a cured film formed by an inkjet method is used.

In particular, the above-described active ray-curable composition is suitably used for forming a transparent layer of an image display device, in particular, a transparent layer for bonding each member of an image display device, since the tackiness of a cured film is high and the transparency can be sufficiently increased. Examples of the transparent layer include a transparent layer for bonding a transparent electrode formed on the substrate with a transparent protective layer made of glass or resin, a transparent layer for bonding various panels such as a liquid crystal display panel, an organic EL display panel, and a touch panel, with a transparent protective layer, a transparent layer for bonding a display panel such as a liquid crystal display panel and an organic EL display panel, with a touch panel, and a transparent layer for bonding other members with each other.

### 2. Method for Forming Cured Film

The above-described active ray-curable composition can be used for forming a cured film.

At this time, the cured film can be obtained by applying the active ray-curable composition to a substrate or one of the members (one member) to be bonded, and curing the applied active ray-curable composition by irradiation with active rays.

The method of applying the active ray-curable composition is not particularly limited, and known methods such as a spray coating method, a dipping method, a screen printing method, a gravure printing method, an offset printing method, and an inkjet method can be used. These application methods may be used alone or in combination of two or more thereof. Of these, an inkjet method is preferable from the viewpoint of forming a fine cured film with precision to form a high-definition pattern (image or the like) or apply it even to a curved portion.

The active ray-curable composition may be applied to various substrates, or may be applied to one member to be bonded when two members are bonded. The material of the substrate or member to be provided is not particularly limited, and may be an inorganic substance such as glass, metal, and ceramic, or an organic substance such as a resin film. The above-described active ray-curable composition can satisfactorily adhere to any of these materials.

At this time, the applied active ray-curable composition may be irradiated with active rays to the extent that the composition is not completely cured, to temporarily cure the applied active ray-curable composition.

When a transparent layer for bonding two different members is formed, the other member is bonded to the applied (or temporarily cured) active ray-curable composition. At this time, at least one of the two members to be bonded is a member that transmits active rays.

Examples of the member that transmits active rays include members each formed of a material such as glass, a (meth)acrylic resin, a polyethylene terephthalate resin, a polyethylene naphthalate resin, a polycarbonate resin, a polyimide resin, or a cycloolefin polymer. On the member formed of these materials, a transparent functional member such as a transparent electrode may be formed.

Examples of the member that does not transmit active rays include members on each which a liquid crystal display panel, an organic EL display panel, a protection panel, a touch panel, an organic EL element, a color filter, and the like are formed.

After the bonding, appropriate pressure may be applied in order to bring these members into close contact with each other or to make the thickness of the active ray-curable composition uniform.

Thereafter, the active ray-curable composition is cured (or fully cured) by irradiation with active rays, whereby a cured film can be obtained. The active rays may be any active rays such as electron beams, ultraviolet rays, α-rays, γ-rays and X-rays, but are more preferably ultraviolet rays from the viewpoint of suppressing damage to other members. In addition, from the viewpoint of suppressing damage to other members due to radiant heat, ultraviolet rays emitted from a light emitting diode (UV-LED) which emits ultraviolet rays as a light source are more preferable.

The cured film thus formed from the above-described active ray-curable composition has high tackiness and excellently maintains the tackiness even in a high-temperature and high-humidity environment or a low-temperature environment. Therefore, when used for bonding two members, separation of these members, particularly separation during long-term use, is less likely to occur.

Furthermore, the tackiness of the cured film is less likely to decrease even when the cured film is repeatedly bent. Therefore, even when the members are used in a flexible display or the like, separation of the members, particularly separation during long-term use, is less likely to occur.

Therefore, a device including the cured film, for example, an image display device including the cured film can be used for a long period of time.

### 3. Apparatus for Producing Cured Film

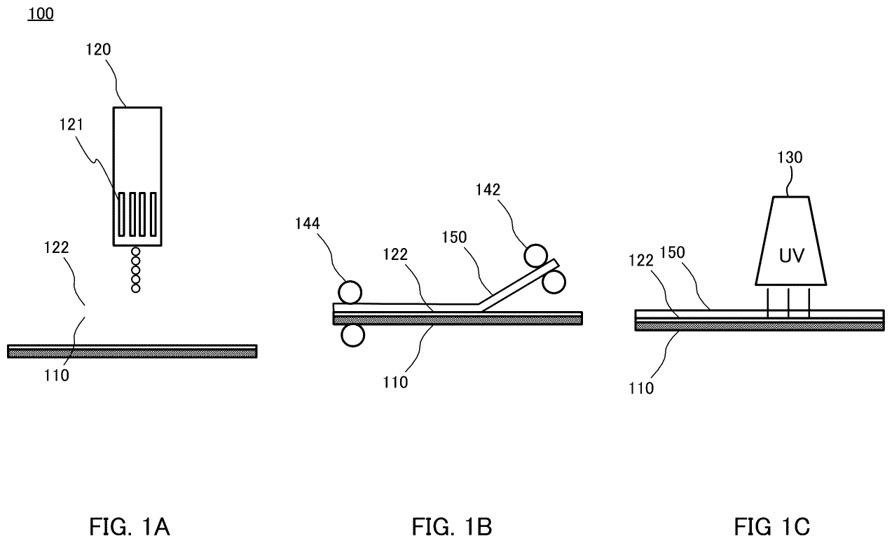

FIGS. 1A to 1C are diagrams each schematically illustrating an exemplary configuration of a cured film producing apparatus for performing the above-described cured film producing method.

The cured film producing apparatus 100 illustrated in FIGS. 1A to 1C includes an applicator 120 for applying the above-described active ray-curable composition onto the surface of the one member 110, and an irradiator 130 for irradiating the surface of the one member 110 on which the active ray-curable composition has been applied with active rays.

The applicator 120 applies the active ray-curable composition by an inkjet method in the present embodiment. The application section 120 ejects the active ray-curable composition from nozzles 121 to apply the active ray-curable composition 122 to a position on the one member 110 where a cured film is to be formed (1A in the figure).

Thereafter, the other member 150 may be applied to the surface of the applied active ray-curable composition 122 by the bonding section 140, and the one member 110 and the other member 150 may be bonded to each other. In the present embodiment, the bonding section 140 feeds the other member 150, which is a transparent film, by a feed roller 142 and applies the other member to the surface of the active ray-curable composition. Next, pressure is applied by the pressure roller 144 so that the one member 110 and the other member 150 are brought into close contact with each other (FIG. 1B).

Note that when the one member 110 is a member that transmits active rays and the other member 150 is a member that does not transmit active rays, the manufacturing apparatus 100 may include a reversing section that reverses these members.

The irradiator 130 applies active rays to the surface of the one member 110 to which the active ray-curable composition 122 has been applied. Thus, the irradiator 130 cures the active ray-curable composition 122 applied to the surface of the one member 110 to form the cured film 124. In the present embodiment, the irradiator 130 irradiates the active ray-curable composition 122 with active rays transmitted through the other member 150 (FIG. 1C).

Note that in the above description, the active ray-curable composition is applied to the surface of the one member 110 by an inkjet method, but the method for applying the active ray-curable composition is not particularly limited, and a known method such as a spray coating method, a dipping method, a screen printing method, a gravure printing method, or an offset printing method can be used.

### EXAMPLES

Hereinafter, the present invention will be described more specifically, but the following description does not limit the present invention.

### 1. Material Preparation

### 1.1. Component (A)

Methyl ethyl ketone (MEK) was added as a solvent to a three-neck flask, and the temperature was raised to 80° C. while blowing nitrogen. A mixed liquid of 83 part of 2-ethylhexyl acrylate (2EHA), 17 parts of 2-hydroxyethyl acrylate (2HEA), and 0.50 parts of azobisisobutyronitrile as a polymerization initiator was added dropwise over 2 hours. After the dropwise addition, the temperature was maintained for 1 hour, and a solution prepared by dissolving 0.1 part of azobisisobutyronitrile in MEK was added dropwise over 1 hour. Thereafter, the mixture was kept warm for about 1 hour, and the reaction mixture was diluted with MEK.

The acrylic polymer solution was added to a separable flask equipped with a stirrer, a thermometer, an air blowing tube, and a vacuum pump, and stirring and temperature increase were started while bubbling air. The temperature was gradually raised to 80° C. while the pressure was reduced, and the pressure reduction was continued while the temperature was kept at 80° C. to obtain an acrylic polymer.

HLC-8220GPC (manufactured by Tosoh Corporation) was used in combination with TSG gel SuperMultiporeHZ 4000 (manufactured by Tosoh Corporation), TSG gel SuperMultiporeHZ 3000 (manufactured by Tosoh Corporation), and TSG gel SuperMultiporeHZ 2500 (manufactured by Tosoh Corporation) columns to measure the weight average molecular weight (Mw) of the (meth)acrylic polymer 1. Tetrahydrofuran (THF) was used as a solvent, the column temperature was set to 40° C., detection was performed by an RI (Refractive Index) detector, and the weight molecular weight in terms of polystyrene was obtained. The measured weight average molecular weight (Mw) of the (meth)acrylic polymer 1 was 60,000.

With reference to JIS K 0070, the hydroxyl value of the (meth)acrylic polymer 1 was measured using a potentiometric titrator (AT-500N, manufactured by Kyoto Electronics Manufacturing Co., Ltd), glass electrodes (C-173, manufactured by Kyoto Electronics Manufacturing Co., Ltd), and an alcohol solution having a KOH concentration of 0.5 mol/L as a titrant. The sample was weighed in a 200 mL Erlenmeyer flask, an acetylating agent 5 mL was added, and the mixture was reacted in an oil bath at 100° C.±5° C. for 1 hour. After being allowed to cool, 1 mL water was added, and the mixture was reacted for 10 minutes in an oil bath of 100° C.±5° C., allowed to cool, then washed away with 5 mL ethanol, and 140 mL pyridine was added for dilution. Titration was performed using a potentiometric titrator, and the obtained inflection point was used as the end point. A blank test was also performed in the same manner, and the hydroxyl value was calculated from the following formula.

$$Hydroxyl value ( mg KOH / g ) = ( V 0 - V 1 ) \times N \times 56.11 \times f / S + acid value$$

S: Weight of sample (g)
V0: Amount of titrant required for blank test (mL)
V1: Amount (mL) of titrant required for the present test
N: Concentration of titrant (0.5 mol/L)
f: Titrant factor (1.001)

The acid values in the above calculation formula are values measured with reference to JIS K 0070 using a potentiometric titrator (AT-500N, manufactured by Kyoto Electronics Manufacturing Co., Ltd.) and glass electrodes (C-173, manufactured by Kyoto Electronics Manufacturing Co., Ltd.) and using alcohol solutions having a KOH concentration of 0.1 mol/L as a titrant. The sample and 80 mL of a mixed solution (toluene:methanol=4:1) (volume ratio) were added to a 100 mL Erlenmeyer flask to dissolve the sample. Titration was performed using a potentiometric titrator, and the obtained inflection point was used as the end point. A blank test was also performed in the same manner, and the acid value was calculated from the following formula.

$$Acid number ( mg KOH / g ) = ( V 1 - V 0 ) \times N \times 56.11 \times f / S$$

S: Weight of sample (g)
V0: Amount of titrant required for blank test (mL)
V1: Amount (mL) of titrant required for the present test
N: Concentration of titrant (0.1 mol/L)
f: Titrant factor (1.001)

The hydroxyl value of the (meth)acrylic polymer 1 measured by the above-mentioned method was 80 mgKOH/g.

The charging ratio of the monomers (2EHA and 2HEA) and the reacting time were changed to obtain solutions of the (meth)acrylic polymer 2 to the (meth)acrylic polymer 10. The weight average molecular weight (Mw) and the hydroxyl value of each of these (meth)acrylic polymers were measured in the same manner as in the case of the (meth)acrylic polymer 1.

The weight average molecular weight (Mw) and the hydroxyl value of the (meth)acrylic polymer 1 to the (meth)acrylic polymer 10 are listed in Table 1 and Table 2.

TABLE 1

| | (Meth)acrylic polymer No | | | | |
|---|---|---|---|---|---|
| | 1 | 2 | 3 | 4 | 5 |
| Weight average | 60,000 | 60,000 | 60,000 | 60,000 | 60,000 |
| molecular weight (Mw) | | | | | |
| Hydroxyl value | 80 | 30 | 115 | 0 | 150 |
| (mgKOH/g) | | | | | |

TABLE 2

| | (Meth)acrylic polymer No | | | |
|---|---|---|---|---|
| | 6 | 7 | 8 | 9 |
| Weight average molecular | 5,000 | 10,000 | 120,000 | 200,000 |
| weight (Mw) | | | | |
| Hydroxyl value (mgKOH/g) | 80 | 80 | 80 | 80 |

### 1-2. Component (B)

As the (meth)acrylate having a hydroxyl group, hydroxybutyl acrylate (HBA) was used.

### 1-3. Component (C)

As the (meth)acrylate having no hydroxyl group, isostearic acid acrylate (ISTA) and isobornyl acrylate (IBXA) were used. Trimethylolpropane triacrylate (TMPTA) was used as a polyfunctional (meth)acrylate.

### 1-4. Component (D)

As the photopolymerization initiators, bis(2,4,6-trimethylbenzoyl) phenylphosphineoxide (manufactured by IGM Resin, Omnirad 819, cleavage type, acylphosphine oxide-based), methyl benzoylformate (manufactured by IGM Resin, Omnirad MBF, hydrogen abstraction type), and 2-hydroxy-2-methyl-1-phenylpropane (manufactured by Lambson, Speedcure 84, cleavage type) were used.

### 2. Preparation of Active Ray-Curable Composition

The above materials were charged into a stainless steel beaker at the ratio shown in Table 1, and stirred for 1 hour while being heated at 80° C. on a hot plate. Thereafter, the mixture was filtered through a filter (PTFE-type membrane filter, pore size 3.00 μm, manufactured by ADVANTEC) to obtain ink 1 to ink 16, each of which was an active ray-curable composition.

The compositions of ink 1 to ink 16 are listed in Tables 3 and 4. Note that the unit of the amount described in Tables 3 and 4 is parts by mass.

TABLE 3

| Ink No | | | 1 | 2 | 3 | 4 | 5 | 6 | 7 | 8 |
|---|---|---|---|---|---|---|---|---|---|---|
| Component (A) | | (Meth)acrylic polymer 1 | 10 | | | | | | | 10 |
| | | (Meth)acrylic polymer 2 | | 10 | | | | | | |
| | | (Meth)acrylic polymer 3 | | | 10 | | | | | |
| | | (Meth)acrylic polymer 4 | | | | 10 | | | | |
| | | (Meth)acrylic polymer 5 | | | | | 10 | | | |
| | | (Meth)acrylic polymer 6 | | | | | | 10 | | |
| | | (Meth)acrylic polymer 7 | | | | | | | 10 | |
| | | (Meth)acrylic polymer 8 | | | | | | | | |
| | | (Meth)acrylic polymer 9 | | | | | | | | |
| Component (B) | | HBA | 30 | 30 | 30 | 30 | 30 | 30 | 30 | 30 |
| Component | No | ISTA | 59 | 59 | 59 | 59 | 59 | 34 | 34 | 34 |
| (C) | cycloaliphatic | | | | | | | | | |
| | structure | | | | | | | | | |
| | With | IBXA | | | | | | 25 | 25 | 25 |
| | cycloaliphatic | | | | | | | | | |
| | structure | | | | | | | | | |
| | Polyfunctional | TMPTA | | | | | | | | |
| Component | Cleavage type | Omnirad 819 | 1 | 1 | 1 | 1 | 1 | 1 | 1 | 1 |
| (D) | Hydrogen | MBF | | | | | | | | |
| | abstraction | | | | | | | | | |
| | type | | | | | | | | | |
| | Cleavage type | Speedcure84 | | | | | | | | |

TABLE 4

| Ink No | | | 9 | 10 | 11 | 12 | 13 | 14 | 15 | 16 |
|---|---|---|---|---|---|---|---|---|---|---|
| Component (A) | | Acrylic polymer 1 | | | | 10 | | | | 10 |
| | | Acrylic polymer 2 | | | | | | | | |
| | | Acrylic polymer 3 | | | | | | | | |
| | | Acrylic polymer 4 | | | | | | | | |
| | | Acrylic polymer 5 | | | 10 | | 5 | 20 | 10 | |
| | | Acrylic polymer 6 | | | | | | | | |
| | | Acrylic polymer 7 | | | | | | | | |
| | | Acrylic polymer 8 | 10 | | | | | | | |
| | | Acrylic polymer 9 | | 3 | | | | | | |
| Component (B) | | HBA | 30 | 30 | 30 | 30 | 30 | 25 | 30 | 30 |
| Component | No | ISTA | 34 | 41 | 34 | 30 | 39 | 29 | 34 | 31 |
| (C) | cycloaliphatic | | | | | | | | | |
| | structure | | | | | | | | | |
| | With | IBXA | 25 | 25 | 25 | 25 | 25 | 25 | 25 | 25 |
| | cycloaliphatic | | | | | | | | | |
| | structure | | | | | | | | | |
| | Polyfunctional | TMPTA | | | | | | | | 3 |
| Component | Cleavage type | Omnirad 819 | 1 | 1 | 1 | | 1 | 1 | | 1 |
| (D) | Hydrogen | MBF | | | | 5 | | | | |
| | abstraction | | | | | | | | | |
| | type | | | | | | | | | |
| | Cleavage type | Speedcure84 | | | | | | | 1 | |

$$Ejection speed = \frac{\sqrt{{( X 2 - X 1 )}^{2} + {( Y 2 - Y 1 )}^{2}}}{Delay time 2} \qquad [ Equation 1 ]$$

### 3. Evaluation

The ink 1 to the ink 16 were evaluated for viscosity, ejection stability from an inkjet head, high-temperature and high-humidity durability of a cured product, low-temperature durability of a cured product, and bending durability of a cured product by the following methods and criteria.

### 3-1. Viscosity

The viscosity of each ink at 25° C. was measured with a rheometer (manufactured by Anton Paar GmbH, Physica MCR301) under the condition of a shear rate of 1000 (1/s).

3-2. Ejection Stability from Inkjet Head

An inkjet head (KM1024iLHE-30, manufactured by Konica Minolta, Inc) was mounted on an inkjet image forming apparatus (manufactured by Tritek, Inc), and ink 1 to ink 16 were continuously ejected with a resolution of 360 dpi×360 dpi while the inks in the channels of the head were heated to a temperature at which the viscosities of the inks were 10 to 11 mPa·s.

At this time, the ejection speed from the single nozzle was set to 6 m/s, and the ejection speed was measured 10 times at one minute intervals from one minute after the start of the continuous ejection.

Note that the ejection speed was measured by the following method.

First, a CCD camera was installed at a position where a space (flight space) lower (base side) than the ejection surface of the ejection head was imaged in a direction parallel to the ejection surface so that the ejected and flying droplets could be imaged from the lateral direction. Furthermore, a strobe light that irradiates the flight space with light was installed at a position opposite to the CCD camera with the flight space interposed therebetween. The strobe light was caused to emit light, and the flying space was continuously imaged by the CCD camera, and thus the flying droplets were continuously imaged.

At this time, the time (delay time 1) from the output of a signal (droplet discharge trigger) for driving the inkjet head to discharge an ink droplet from each nozzle to the emission of light from the strobe light and the imaging of the flight space by the CCD camera was set to 100 psec. In addition, a time period (delay time 2) from the delay time 1 until the strobe light is caused to emit light and the next image of the flight space is captured by the CCD camera is set to 100 sec.

Next, from the image captured at the delay time 1, the position of the center of gravity of the ink droplet in the image was obtained, and the position of the center of gravity was specified by the positions on the orthogonal X axis and Y axis set in the image. The position of the center of gravity of the ink droplet at the delay time 1 was defined as (X1, Y1). The position of the center of gravity of the same ink droplet in the image was also obtained from the image captured at the delay time 2, and the position of the center of gravity was similarly specified. The position of the center of gravity of the ink droplet at the delay time 2 was defined as (X2, Y2).

Then, the ejection speed of the ink droplet was obtained by the following equation.

$$Ejection speed = \frac{\sqrt{{( X 2 - X 1 )}^{2} + {( Y 2 - Y 1 )}^{2}}}{Delay time 2} \qquad [ Equation 1 ]$$

Of the ejection speeds measured 10 times at one minute intervals, the maximum ejection speed was used as the maximum speed, and the minimum ejection speed was used as the minimum speed, and the fluctuation value of the speed was determined by the following formula.

$$Fluctuation value ( \% ) = \frac{( Maximum speed - Minimum speed )}{Average speed} \times 100 \qquad [ Equations 2 ]$$

$$Average speed = \frac{( Maximum speed + Minimum speed )}{2}$$

The fluctuation value of the speed obtained above was used to evaluate the ejection stability of each ink from the inkjet head according to the following criteria.
⊚ Fluctuation value of the speed is 5% or less
∘ Fluctuation value of the speed is greater than 5% and equal to or less than 30%
x Fluctuation value of the speed is greater than 30%
x x No ink is ejected from the nozzles

### 3-3. High-Temperature and High-Humidity Durability of Cured Product

Using the inkjet image forming apparatus and the inkjet head used in “3-2. Ejection stability from inkjet head”, each ink was applied to a glass plate as a substrate so as to have a film thickness of 50 μm. The applied ink was irradiated with ultraviolet rays having a wave length of 395 nm at an intensity of 200 mW/cm² by using an ultraviolet ray irradiation apparatus (manufactured by Phoseon). The integrated light amount was defined as 1000 mJ/cm². A transparent PET film (thickness: 50 μm) was bonded to the surface of the ink that had been temporarily cured by the irradiation, and the ink was then fully cured by irradiation with ultraviolet rays having the wave length 395 nm at an intensity of 200 mW/cm² and an integrated light quantity of 1000 mJ/cm² to an obtain test piece (hereinafter, also referred to as “peel test piece”) in which the cured film of each ink was sandwiched between the glass plate and the PET film.

The peel test pieces obtained from the respective inks were each placed in a tensile tester (TG-MIBEA, 2 kN, manufactured by Minebea Co., Ltd) and subjected to a 180° peel test at a tensile rate of 60 mm/min. The mean value of the stresses generated when about the 60 mm of the PET film was peeled off was used as the peel force (before storage) of the cured product of the ink.

The peel test piece obtained from each ink was stored in a thermostatic chamber set at a temperature of 85° C. and a relative humidity of 85%, and taken out after 500 hours. The cured product after storage was subjected to a 180° peel test under the same conditions, and the mean value of the stresses generated when about 60 mm of the PET film was peeled off was used as the peeling force (after high-temperature and high-humidity storage) of the cured product for the ink.

The ratio of fluctuation in the peeling force (after high-temperature high-humidity storage) relative to the peeling force (before storage) was determined, and the high-temperature and high-humidity durability of the cured product of each ink was evaluated according to the following criteria.
⊚⊚ Ratio of fluctuation is 2.5% or less
⊚ Ratio of fluctuation is greater than 2.5% and 5% or less
∘ Ratio of fluctuation is greater than 5% and 30% or less
x Ratio of fluctuation is greater than 30% or less and 50% or less
x x Ratio of fluctuation is greater than 50%

### 3-4. Low-Temperature Durability of Cured Product

The peel test piece of each ink used in “3-3. High-temperature and high-humidity durability of cured product” was stored in a thermostatic bath set to a temperature of 0° C., and taken out after 500 hours. The peel test piece after storage was subjected to a 180° peel test under the same conditions, and the mean value of the stresses when approximately 60 mm of the PET film was peeled off was taken as the peel strength (after low-temperature storage) of the cured product of the ink.

The ratio of fluctuation in the peeling force (after low-temperature storage) relative to the peeling force (before storage) was determined, and the high-temperature and high-humidity durability of the cured product of each ink was evaluated according to the following criteria.
⊚ Ratio of fluctuation is 5% or less
∘ Ratio of fluctuation is greater than 5% and 30% or less
x Ratio of fluctuation is greater than 30% or less

### 3-5. Bending Durability of Cured Product

Using the inkjet image forming apparatus and the inkjet head used in “3-2. Ejection stability from inkjet head”, each ink was applied to a PET film (film thickness of 50 μm) as a substrate so as to have a film thickness of 30 μm. The applied ink was irradiated with ultraviolet rays having a wave length of 395 nm at an intensity of 200 mW/cm² by using an ultraviolet ray irradiation apparatus (manufactured by Phoseon). The integrated light amount was defined as 1000 mJ/cm². A transparent PET film (thickness: 50 μm) was bonded to the surface of the ink temporarily cured by the irradiation, and the ink was then fully cured by irradiation with ultraviolet rays having wavelength of 395 nm at an intensity of 200 mW/cm² and an integrated light amount of 1000 mJ/cm², thereby obtaining a test piece (hereinafter, also referred to as “bent test piece”) in which the cured film of each ink was sandwiched between two PET films.

The bend test pieces obtained from the respective inks were each placed in a bending resistance tester, and a bending test was performed 100,000 times with R=2 mm. The cured film after the test was visually observed, and the bending durability of the cured product of each ink was evaluated according to the following criteria based on a change such as white turbidity with respect to the cured film before the test.
⊚ No change such as white turbidity is confirmed
∘ Change such as cloudiness is faintly confirmed
Δ Slight change such as white turbidity is confirmed
x Change such as white turbidity is clearly confirmed

The weight average molecular weight (Mw) and the hydroxyl value of the component (A) added to each ink, and the evaluation results of each ink are shown in Table 5 and Table 6.

TABLE 5

| | | | | | Comparative | | Comparative | | |
|---|---|---|---|---|---|---|---|---|---|
| | | Example | Example | Example | example | Example | example | Example | Example |
| Ink No | | 1 | 2 | 3 | 4 | 5 | 6 | 7 | 8 |
| Component | Mw | 60,000 | 60,000 | 60,000 | 60,000 | 60,000 | 5,000 | 10,000 | 60,000 |
| (A) | Hydroxyl value | 80 | 30 | 115 | 0 | 150 | 80 | 80 | 80 |
| | (mgKOH/g) | | | | | | | | |
| Evaluation | Viscosity at 25° C. | 35.1 | 32.5 | 35.5 | 32.9 | 40.2 | 15.2 | 16.3 | 38.0 |
| | (mPa · s) | | | | | | | | |
| | Ejection stability | ⊚ | ⊚ | ⊚ | ⊚ | ◯ | ⊚ | ⊚ | ⊚ |
| | High temperature | ◯ | ◯ | ◯ | XX | ◯ | X | ◯ | ⊚ |
| | and high humidity | | | | | | | | |
| | durability | | | | | | | | |
| | Low-temperature | ⊚ | ◯ | ◯ | X | ◯ | X | ◯ | ⊚ |
| | durability | | | | | | | | |
| | Bending | ⊚ | ⊚ | ⊚ | X | ⊚ | X | ⊚ | ⊚ |
| | durability | | | | | | | | |

TABLE 6

| | | | Comparative | | | | | | |
|---|---|---|---|---|---|---|---|---|---|
| | | Example | example | Example | Example | Example | Example | Example | Example |
| Ink No | | 9 | 10 | 11 | 12 | 13 | 14 | 15 | 16 |
| Component | Mw | 120,000 | 200,000 | 60,000 | 60,000 | 60,000 | 60,000 | 60,000 | 60,000 |
| (A) | Hydroxyl value | 80 | 80 | 150 | 80 | 150 | 150 | 150 | 80 |
| | (mgKOH/g) | | | | | | | | |
| Evaluation | Viscosity at 25° C. | 45.8 | 40.5 | 40.9 | 41.3 | 38.9 | 39.1 | 44.0 | 39.0 |
| | (mPa · s) | | | | | | | | |
| | Ejection stability | ◯ | XX | ◯ | ⊚ | ◯ | ◯ | ◯ | ⊚ |
| | High temperature | ◯ | to | ⊚ | ⊚ | ⊚ | ⊚ | ⊚ | ⊚⊚ |
| | and high humidity | | | | | | | | |
| | durability | | | | | | | | |
| | low-temperature | ◯ | to | ◯ | ⊚ | ◯ | ◯ | ◯ | ⊚ |
| | durability | | | | | | | | |
| | Bending | ⊚ | to | ⊚ | Δ | ⊚ | ⊚ | ◯ | ⊚ |
| | durability | | | | | | | | |

As is clear from Tables 5 and 6, according to the active ray-curable composition containing the component (A) to the component (D), it was possible to obtain a cured film which had satisfactory ejection stability and was satisfactory in all of durability in a high-temperature and high-humidity environment, durability at low temperature, and durability against bending.

This application claims the benefit of Japanese Patent Application No. 2022-085423, filed May 25, 2022. The matters described in the specification, the claims, and the drawings at the time of filing of the application are incorporated into the present application by reference.

### INDUSTRIAL APPLICABILITY

According to the present invention, it is possible to obtain a cured film with which a high-definition pattern can be formed by an inkjet method and which has high durability in a high-temperature and high-humidity environment or a low-temperature environment and high durability against bending. The present invention is expected to enhance the durability of cured films used in various applications, in particular, in image display devices, and to contribute to the further spread of cured films formed by an inkjet method.

### REFERENCE SIGNS LIST

100 Cured film producing apparatus
110 One member
120 Applicator
122 Active ray-curable composition
124 Cured film
130 Irradiator
140 Bonding section
142 Feed roller
144 Pressure roller
150 The other member

1. An active ray-curable composition, comprising:
component (A): a (meth)acrylic polymer having a weight average molecular weight of 10,000 or more and 150,000 or less and a hydroxyl value of 30 mgKOH/g or more;
component (B): a (meth)acrylate having a hydroxyl group;
component (C): a (meth)acrylate having no hydroxyl group; and
component (D): a photopolymerization initiator,
wherein,
a viscosity of the active ray-curable composition at 25° C. is 10 mPa·s or more and 200 mPa·s or less.

2. The active ray-curable composition according to claim 1, wherein the component (C) comprises a (meth)acrylate having an alicyclic structure.

3. The active ray-curable composition according to claim 1, wherein the component (C) comprises a (meth)acrylate having no alicyclic structure.

4. The active ray-curable composition according to claim 1, wherein the component (B) or the component (C) comprises a polyfunctional (meth)acrylate.

5. The active ray-curable composition according to claim 1, wherein the component (A) is the (meth)acrylic polymer having the weight average molecular weight of 20,000 or more and 100,000 or less.

6. The active ray-curable composition according to claim 1, wherein the component (D) is an intramolecular bond cleavage type photopolymerization initiator.

7. The active ray-curable composition according to claim 1, wherein the component (D) is an acylphosphine oxide-based photopolymerization initiator.

8. The active ray-curable composition according to claim 1, wherein the component (B) is contained in an amount of 25% by mass or more based on a total mass of the active ray-curable composition.

9. The active ray-curable composition according to claim 1, wherein the component (A) is the (meth)acrylic polymer having the hydroxyl value of 30 mgKOH/g or more and 120 mgKOH/g or less.

10. The active ray-curable composition according to claim 1, wherein the active ray-curable composition is an inkjet ink.

11. The active ray-curable composition according to claim 1, wherein the active ray-curable composition is used for forming a transparent layer of an image display device.

12. A method for producing a cured film, the method comprising:
applying the active ray-curable composition according to claim 1; and
irradiating the applied active ray-curable composition with an active ray.

13. A cured film obtained by curing the active ray-curable composition according to claim 1.

14. The cured film according to claim 13, wherein the cured film is a transparent layer of an image display device.

15. An image display device comprising the cured film according to claim 13.

16. An apparatus for producing a cured film, the apparatus comprising:
an applicator that applies the active ray-curable composition according to claim 1 to a substrate; and
an irradiator that irradiates the applied active ray-curable composition with an active ray.
